(19) United States
(12) Patent Application Publication
(10) Pub. No.: US 2025/0028822 A1
(43) Pub. Date: Jan. 23, 2025

(54) Multi-Mode Configurable Magnetic Antenna Array for Detecting and Defending Against Malicious Attacks on Semiconductor Integrated Circuits

(71) Applicant: University of Florida Research Foundation, Incorporated, Gainesville, FL (US)

(72) Inventors: Shuo WANG, Gainesville, FL (US); Hanqiu WANG, Gainesville, FL (US)

(21) Appl. No.: 18/440,187

(22) Filed: Feb. 13, 2024

Related U.S. Application Data
(60) Provisional application No. 63/485,134, filed on Feb. 15, 2023.

(51) Int. Cl. G06F 21/56; H01Q 1/22; H01Q 1/52; H01Q 7/00

(52) U.S. Cl. CPC G06F 21/56; H01Q 1/2283; H01Q 1/526; H01Q 7/00; G06F 2221/034

(57) ABSTRACT

An integrated circuit providing hardware security. The integrated circuit comprising a wire grid, wherein the wire grid comprises: (i) a wire grid spanning two metal layers comprising horizontal wires and vertical wires, (ii) a switch at each intersection of the horizontal wires and the vertical wires, wherein each switch comprises a transmission gate, (iii) one or more loop areas, wherein, for each intersection, the transmission gate is programmable to control connectivity at the intersection forming the one or more loop areas, and (iv) one or more amplifiers configured with the loop areas to provide one or more functions including (a) detecting trojans, (b) defending against fault injections by partially canceling injected magnetic fields with induced currents, (c) cancel fault injections by canceling injected magnetic fields, or (d) masking side-channel leakage by generate noising magnetic fields.

### CROSS REFERENCE TO RELATED APPLICATION

This application claims the priority of U.S. Provisional Application No. 63/485,134, entitled “MULTI-MODE CONFIGURABLE MAGNETIC ANTENNA ARRAY FOR DETECTING AND DEFENDING AGAINST MALICIOUS ATTACKS ON SEMICONDUCTOR INTEGRATED CIRCUITS,” filed on Feb. 15, 2023, the disclosure of which is hereby incorporated by reference in its entirety.

### TECHNICAL FIELD

Various embodiments of the present disclosure relate to improving security of integrated circuits, and more particularly to a defense mechanism and technique against side channel attacks, fault injections and hardware trojans in integrated circuit designs.

### BACKGROUND

Microprocessors/digital integrated circuits (ICs) may generate high-frequency currents that in turn generate high frequency magnetic fields, as depicted in FIG. 1. At a distance r significantly smaller than a wavelength, for example, in the space above or below an IC, a near magnetic field may be dominantly present. A near magnetic flux density B is proportional to the product of the current magnitude I and the current loop area A, and inversely proportional to r³, as given by the following:

$$B ( t ) ∞ AI ( t ) / {r}^{3} \qquad Equation 1$$

As a result, the near magnetic flux density may be modulated by a current generated by a microprocessor/digital IC. At the same time, the current may be modulated by the activities of the IC. Activities such as encryptions and computations may have specific signatures that are reflected in the currents and thus in near magnetic field emitted by the microprocessor/digital IC. By analyzing the measured near magnetic field emitted from the microprocessor/digital IC, it is possible to achieve different attack or defense objectives.

Near magnetic field may be used to achieve magnetic-field based side-channel attacks or fault injections. It is also an important characteristic of hardware Trojans (HTs). Magnetic-field based side-channel attacks may be conducted with the help of information carried in a sensed near magnetic field of a microprocessor/digital IC. Moreover, magnetic-field based fault injections may be conducted with strong near magnetic field injections.

The activities of HTs may affect near magnetic fields with their signatures. HTs have been a growing concern in the hardware security community as third-party designs and manufacturing are increasingly used. An HT can be designed with different objectives e.g., payloads, such as leaking protected information, denying service, and improperly elevating access. HTs can be either always active or only active when certain external or internal criteria e.g., when a trigger occurs. Properly designed triggers may allow HTs to avoid detection during testing. As such, research on techniques to detect HTs through the analysis of side-channel effects have been conducted.

Side channel effects may comprise signal vectors, such as power draw or electromagnetic (EM) emanations that indirectly convey insights into operations being performed on hardware. Side channels can be detected after a chip is fabricated, either in a test phase or during run-time with external sensing equipment or devices. As an example, EM side channel analysis may comprise employing an external EM probe above a package of an IC connected to an oscilloscope that is recording voltages induced in a probe by a leakage EM field B(t) from the IC. The induced voltage V(t) at the probe may represent the change rate of the leakage magnetic flux according to the following equation:

$$V ( t ) = A \cdot dB ( t ) / dt \qquad Equation 2$$

where A may represent a probe loop area vector. A recorded |V(t)| may be compared with values without HTs in either time domain or frequency domain after fast Fourier transformation. The presence of HTs can be determined by the difference of |V(t)| for the cases with HTs and the values without HTs.

A magnetic field probe may typically be placed above an IC since power metal layers are at the top of the IC, which results in strong EM side channel effects. However, the size of the magnetic field probe and the distance between the magnetic field probe and the magnetic field source on an IC limit measurement resolution and sensitivity. This has led to interest in on-chip sensors, or sensors built into an IC design to analyze side channels more precisely, closely, or accurately. One of the main challenges of on-chip EM sensors is the balance between sensing area, accuracy, and cost. HTs can emit time-varying magnetic field-inducing voltages within nearby metal coils in the probe. For example, a single large sensing coil may cover an entire sensor and be relatively easy to design and implement but could be inaccurate. Moreover, a single coil may fail to detect one of a plurality of digital HTs integrated into a chip. Multiple smaller coils on the same layer may improve the overall resolution but have smaller signal magnitudes and low coverage. Coils stacked across multiple additional metal layers to mitigate overlap may avoid the aforementioned issues but incur even more expenses and raise issues of conflicting detections.

There is thus a need for an on-chip defense mechanism capable of detecting, identifying, and defending microprocessor or digital ICs against attacks.

### BRIEF SUMMARY

Various embodiments described herein relate to methods, apparatuses, and systems for integrating the functions of attack detection, identification, and defense at the on-chip hardware level to efficiently and comprehensively combat magnetic-field based side-channel attacks, magnetic-field based fault injections, and embedded hardware Trojans (HTs) in integrated circuits. In some embodiments, an on-chip magnetic antenna array may be provided for detecting HTs and accurately locating magnetic leakage regions of HTs. In some embodiments, a cross-domain technique is provided to detect and identify HTs based on measured magnetic field data across time and frequency domains.

According to some embodiments, an integrated circuit comprises a magnetic antenna array. In some embodiments, the magnetic antenna array comprises a wire grid spanning two metal layers comprising horizontal wires and vertical wires; a switch at each intersection of the horizontal wires and the vertical wires, wherein each switch comprises a transmission gate; and one or more antenna loops, wherein for each intersection, the transmission gate is programmable to control connectivity at the intersection forming the one or more antenna loops.

In some embodiments, at least one of shape, location, or size of the wire grid are configurable by enabling selected ones of switches associated with one or more intersections of the horizontal wires and the vertical wires. In some embodiments, the magnetic antenna array is configured to locate magnetic field leakage of hardware Trojans. In some embodiments, an induced voltage output is generated by the magnetic antenna array based on a capture of electromagnetic emissions from hardware Trojans by the wire grid. In some embodiments, the integrated circuit further comprises an operational amplifier configured to amplify the induced voltage output. In some embodiments, the one or more antenna loops comprise one or more loop units. In some embodiments, the one or more antenna loops are configurable in at least one of a detection mode, a shielding mode, or a cancelation and interference mode. In some embodiments, the shielding mode comprises activation of T-gates on each corner of a selected loop unit to create a short circuit. In some embodiments, the selected loop unit generates an inverse magnetic field based on a short circuit current associated with voltage induced by a magnetic field penetrating the selected loop unit. In some embodiments, the cancelation and interference mode comprises generating a noisy magnetic field.

According to some embodiments, a computer-implemented method comprises receiving, by one or more processors, frequency spectrum data based on induced voltage measured of an integrated circuit, the spectrum data received from a magnetic antenna array embedded within the integrated circuit, the magnetic antenna array comprising a wire grid, wherein the wire grid comprises (i) a wire grid spanning two metal layers comprising horizontal wires and vertical wires, (ii) a switch at each intersection of the horizontal wires and the vertical wires, wherein each switch comprises a transmission gate, and (iii) one or more sensing areas; determining, by the one or more processors, one or more spectrum signatures in the spectrum data by comparing the spectrum data with spectrum data without active hardware Trojans; for each of the spectrum signatures, analyzing, by the one or more processors, one or more frequency components of a spectrum signature in a time domain based on a magnitude change as a function of time; and determining, by the one or more processors, an identification of one or more hardware Trojans by comparing the one or more frequency components of the spectrum signature with frequency components of one or more known hardware Trojans.

In some embodiments, the method further comprises measuring magnetic field leakage of the integrated circuit based on a configuration of the magnetic antenna array in a detection mode; generating magnetic field leakage traces based on the measured magnetic field leakage; calculating T-scores for the magnetic field leakage traces; comparing the T-scores with reference T-scores associated with magnetic field leakage traces not associated with the one or more known hardware Trojans; and determining a presence of the one or more hardware Trojans based on the comparison. In some embodiments, the method further comprises generating a T-score heatmap based on the calculated T-scores; and determining one or more leakage locations associated with the one or more hardware Trojans based on the T-score heatmap. In some embodiments, the method further comprises detecting a potential malicious attack or vulnerability comprising a magnetic field located within the integrated circuit; comparing a trace of the magnetic field with known magnetic field patterns; determining the potential malicious attack or vulnerability is an actual malicious attack or vulnerability based on the comparison; determining an attack type of the actual malicious attack or vulnerability; and determining one or more actions based on the attack type.

According to some embodiments, an integrated circuit comprises a target circuit; and a magnetic antenna array embedded within the target circuit. In some embodiments, the magnetic antenna array comprises one or more antenna loops formed by a plurality of connections between a plurality of intersecting horizontal and vertical wires. In some embodiments, the magnetic antenna array is configured to reduce magnetic field leakage by detecting a magnetic field leakage of a target circuit by configuring the magnetic antenna array to operate in a detection mode; inversely amplifying the one or more antenna loops based on the magnetic field leakage; and canceling the magnetic field leakage by configuring the magnetic antenna array in a cancelation mode that injects electrical currents into the one or more antenna loops of the magnetic antenna array.

In some embodiments, the magnetic antenna array is configured to modify the magnetic field leakage by operating in an interference mode that causes the magnetic antenna array to generate a magnetic field interference that is coincident with the magnetic field leakage. In some embodiments, the magnetic antenna array is configured to mask the magnetic field leakage by operating in an interference mode that causes the magnetic antenna array to generate a noisy magnetic field interference that is coincident with the magnetic field leakage. In some embodiments, the magnetic antenna array is configured to defend the target circuit against one or more magnetic field fault injections by operating in a detection mode that causes the magnetic antenna array to detect a magnetic field fault injection on the target circuit; and operating in a shielding mode that causes the magnetic antenna array to enable one or more transmission gates that are adjacent to a location of the magnetic field fault injection to shield the magnetic field fault injection. In some embodiments, the location of the magnetic field fault injection is associated with one or more antenna loop units comprising highest induced voltages.

### BRIEF DESCRIPTION OF THE DRAWINGS

Embodiments incorporating teachings of the present disclosure are shown and described with respect to the figures presented herein.

FIG. 1 illustrates an example of high frequency magnetic fields generated by a microprocessor/digital integrated circuit.

FIG. 2 illustrates a visualization of example T-scores at various locations above a target IC.

FIG. 3 illustrates a magnetic core structure for fault injections.

FIG. 4 illustrates a visualization of example T-scores representative of magnetic field leakage of hardware Trojans.

FIG. 5A and FIG. 5B illustrates an on-chip magnetic antenna array in accordance with some embodiments discussed herein.

FIG. 6A and FIG. 6B illustrate examples of possible magnetic antenna array configurations by controlling of transmission gate switches in accordance with some embodiments discussed herein.

FIG. 7 illustrates example measurement capabilities of a conventional magnetic probe.

FIG. 8 illustrates a full wave three-dimensional simulation of a conventional probe.

FIG. 9 illustrates a full wave three-dimensional simulation of magnetic antenna array in accordance with some embodiments discussed herein.

FIG. 10 illustrates simulated measurements of induced voltage output of a convention probe and a magnetic antenna array in accordance with some embodiments discussed herein.

FIG. 11 depicts an example configuration of a wire grid of a magnetic antenna array in accordance with some embodiments discussed herein.

FIG. 12A illustrates a magnetic field generated during shielding mode operation of a magnetic antenna array in accordance with some embodiments discussed herein.

FIG. 12B illustrates a magnetic field generated during cancelation and interference mode operation of a magnetic antenna array in accordance with some embodiments discussed herein.

FIG. 13A illustrates an example circuit configuration with a multi-mode configurable on-chip magnetic antenna array in accordance with some embodiments discussed herein.

FIG. 13B illustrates an example simulated signal to noise ratio of a multi-mode configurable on-chip magnetic antenna array in accordance with some embodiments discussed herein.

FIG. 14 illustrates simulated magnetic field distributions of an injected magnetic field and an application of an induced cancelation magnetic field to the injected magnetic field in accordance with some embodiments discussed herein.

FIG. 15A and FIG. 15B illustrate example differential amplifiers for increasing input impedance in accordance with some embodiments discussed herein.

FIG. 16 illustrates a frequency response characterizing adjustment to poles of op amps to compensate for magnetic antenna array output impedance and op amp gain characteristics in accordance with some embodiments discussed herein.

FIG. 17 illustrates a flowchart of a method for preventing malicious attacks on a microprocessor or digital integrated circuit in accordance with some embodiments discussed herein.

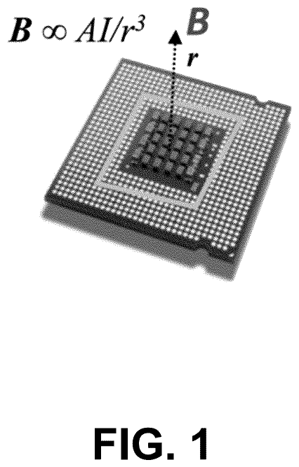

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Exemplary Technical Improvements

The present disclosure provides a multi-mode configurable on-chip magnetic antenna array that may help increase resistance and resilience to tampering of microprocessors or integrated circuits (ICs) by embedding the microprocessors or ICs with the magnetic antenna array.

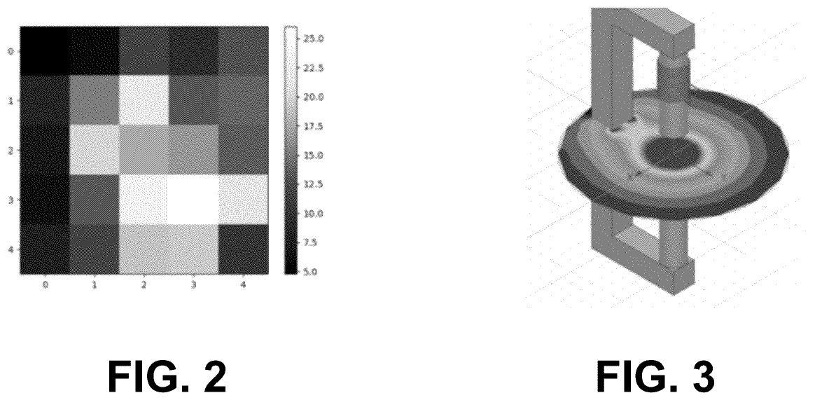

Near magnetic fields can be used by attackers for different side-channel attacks. As an example, to recover a key in an encryption process, attackers may first identify locations of magnetic field leakage by calculating T-scores (e.g., finding a substantial difference) between measured magnetic field leakage traces associated with random plaintext and those with semi-plaintext. A T-score heat map may be generated based on T-scores at various locations above a target IC, as depicted in FIG. 2. Attackers may then recover the key by using correlation electromagnetic analysis (CEMA) or artificial intelligence (AI) to find correlations between patterns of identified magnetic field leakage traces and patterns of the magnetic field leakage traces of known keys.

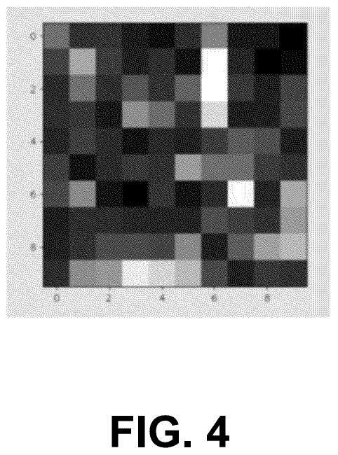

Attackers may also inject malicious magnetic fields into microprocessors/digital ICs to generate faults. Injecting a strong high-frequency magnetic field into microprocessors/digital ICs may induce voltages in circuit loops inside the microprocessors/digital ICs and lead to false gate triggering, bit flipping, or faults. Fault injections may also be achieved by injecting high-frequency currents into a coil wound on a high permeability magnetic core. A magnetic core can help to reduce the reluctance of the magnetic flux, such that an injected magnetic field has a high magnitude and good focus. Magnetic core structures leading to the smallest reluctance give the highest success rate of fault injections, as depicted in FIG. 3.

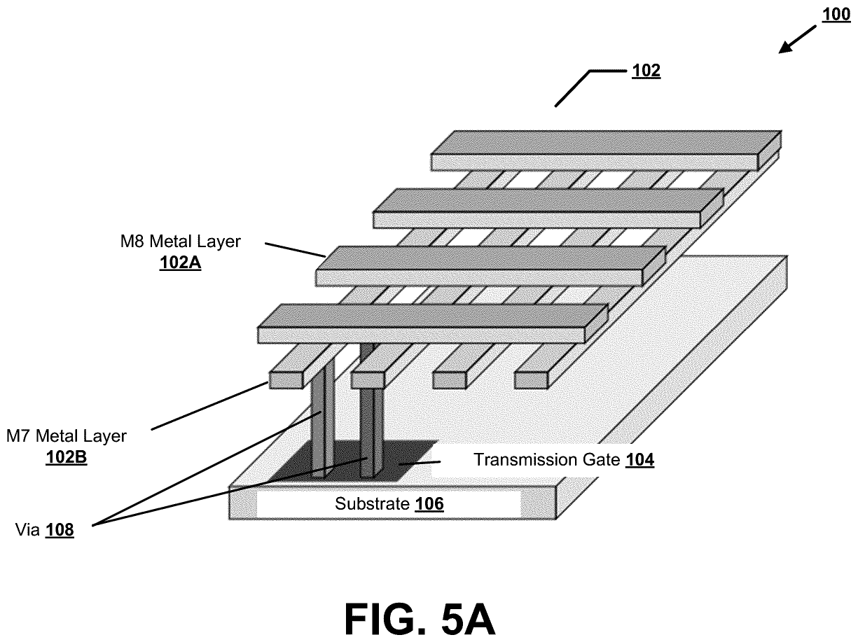

Hardware Trojans (HTs) may comprise malicious modifications introduced in manufactured ICs. For example, HTs may comprise malicious modifications of circuitry or malicious circuits implanted in targeted ICs, typically during fabrication or design by an adversary at different portions of the IC design pipeline. They can generate magnetic fields with their signatures when they are active. As such, the magnetic fields of HTs can be sensed using a magnetic field probe. The sensed magnetic field leakage traces at various locations above the ICs can be compared using T-scores with the ones without the HTs or the ones when inactive HTs to determine the presence of HT. Magnetic field leakage traces at locations with high T-scores on a T-score heatmap, as depicted in FIG. 4, may be representative of the magnetic field leakage of HTs. A HT could be further identified by finding the correlations between the patterns of the identified magnetic field leakage traces and the patterns of the magnetic field leakage traces of various known HT in the database.

The disclosed multi-mode configurable on-chip magnetic antenna array integrates the functions of attack detection, identification, and defense at the on-chip hardware level to efficiently and comprehensively combat magnetic-field based side-channel attacks, magnetic-field-based fault injections, and embedded HTs in ICs. Focusing on the magnetic field characteristics of the aforementioned attacks, the disclosed on-chip antenna array may be configured in a detection mode, a shielding mode, and a cancelation and interference mode, to detect, identify, and defend against attacks. The disclosed defense multi-mode configurable on-chip magnetic antenna array can be integrated with microprocessors and ICs.

### Example Magnetic Antenna Array Design

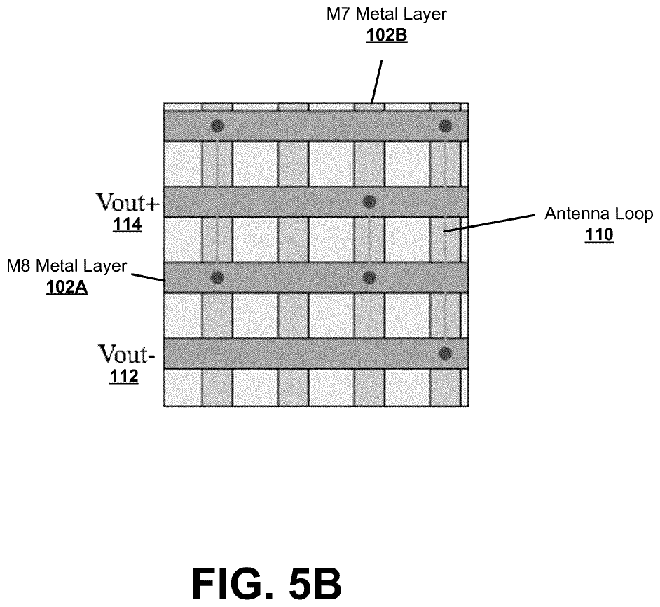

The present disclosure provides an on-chip magnetic antenna array that may be embedded on microprocessors and digital ICs for defending against side-channel attacks, fault injections and HTs. FIG. 5A depicts a multi-mode configurable on-chip magnetic antenna array according to some embodiments of the present disclosure. Magnetic antenna array 100 comprises a wire grid 102 spanning two metal layers, M8 metal layer 102A and M7 metal layer 102B, and a switch at every intersection between wires of the M8 metal layer 102A and M7 metal layer 102B. As an example, M8 metal layer 102A may comprise a plurality (e.g., 36) of horizontal wires on the M8 metal layer and M7 metal layer 102B may comprise a plurality (e.g., 36) of vertical wires on the M7 metal layer. Each intersection of the plurality of horizontal wires and the plurality of vertical wires associated with the M8 metal layer and the M7 metal layer 102B, respectively, may comprise a plurality (e.g., 1296) of switches that may be enabled and disabled. A transmission gate (T-gate) 104, comprising polysilicon including a single PMOS and NMOS gate connected in parallel, may be used to control connectivity of each intersection. By enabling certain switches, antenna loops of different shapes, sizes, and locations within wire grid 102 can be programmed by a user at runtime. Additionally, antenna loops may be configured to operate in one of a plurality of operation modes, such as detection, shielding, and cancelation and interference by enabling certain switches in the antenna loops.

T-gate 104 may be programmed to control the connectivity of each intersection in the wire grid 102. Hence, the shape, location, or size of antenna loops within the wire grid 102 can be programmed. As such, wire grid 102 can be programmed to change location, size, or shape to include and exclude specific parts of magnetic antenna array 100, for example, for fine-tune sensing and detecting magnetic field leakage generated by malicious attacks, such as HTs (e.g., Trojan emission regions), or negating or defending against the malicious attacks.

In some embodiments, the size of the magnetic antenna array 100 can be programmed to adapt to size and shape of HT side-channel leakage such that the highest electromagnetic (EM) emissions from the HTs may be captured. An induced voltage output may be generated by the magnetic antenna array 100 (e.g., a Vout signal) based on a capture of EM emissions from the HTs by the wire grid 102. The induced voltage output may be fed to a compensated operational amplifier (OPAM) to amplify the induced voltage output for the detection and identification of HTs.

In one example embodiment, the magnetic antenna array 100 is integrated above a substrate 106 of a microprocessor on M8 metal layer 102A and M7 metal layer 102B that are above power wire layers M5 and M6. The metal wires on M8 metal layer 102A and M7 metal layer 102B are perpendicular and are connected to T-gate 104 that are connected with a pair of via 108 at each intersection of the wire grid 102. The T-gate 104 can be either enabled to connect two perpendicular wires or disabled to disconnect the two wires.

FIG. 5B is an example antenna loop formed by a connection of select T-gates according to some embodiments of the present disclosure. By controlling the T-gates, different wires can be configured to form different desired shapes of antenna loops at desired locations. The magnetic field emitted from either power layers M5 and M6 or other layers may be coupled to form antenna loops, such as antenna loop 110 comprising an induced voltage associated with Vout− 112 and Vout+ 114 at respective ends of the antenna loop 110.

The number of wires on M8 metal layer 102A and M7 metal layer 102B may be designed based on a tradeoff between overhead, performance, and/or resolution. For example, more wires may result in more T-gates and smaller antenna loops, which may lead to higher resolution and more accurate locations but at the expense of bigger overhead and lower induced voltages. Small distances between the power layers M5 and M6 and the magnetic antenna array layers (e.g., M8 metal layer 102A and M7 metal layer 102B) of the magnetic antenna array 100 may provide sensitivity and spatial resolution that is an improvement over any state-of-the-art discrete magnetic probe.

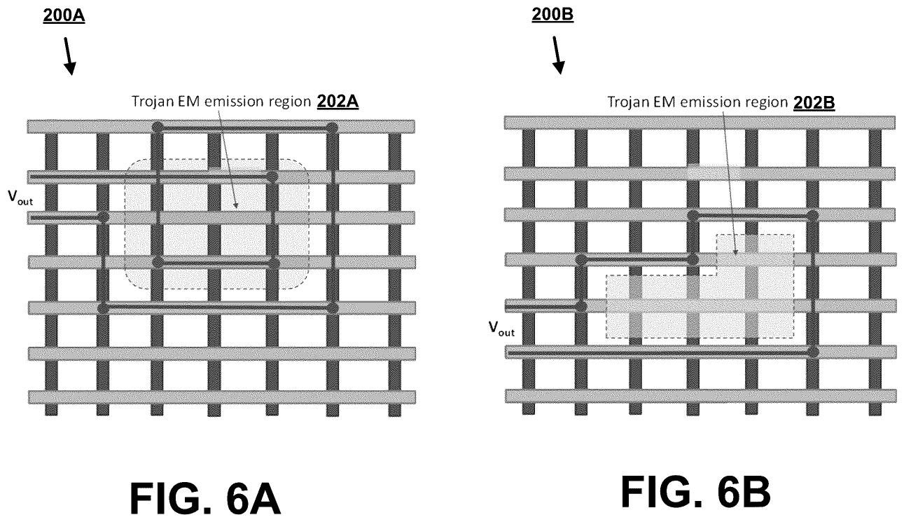

FIG. 6A and FIG. 6B are two example embodiments of magnetic antenna array configurations that may be generated by controlling T-gate switches. Each intersection of wire grid 102 may be enabled or disabled by programming T-gates. By enabling T-gates at different intersections, the disclosed magnetic antenna array may generate and adapt antenna loops to different sizes and shapes. According to various embodiments of the present disclosure, the disclosed magnetic antenna array may be configured in a plurality of operation modes, such as detection, shielding, and cancelation and interference, which are described in further detail below. The antenna loops may be configured to different sizes and shapes to provide coverage in detection, shield, and canceling or interfering of the above-described malicious attacks. For example, by changing the location, size, and shape of coverage (via enabling of intersections on wire grid 102) and tracking a highest output from the magnetic antenna array, it is possible to locate an exact region of magnetic field emission from a Trojan and outline its shape.

As an example, FIG. 6A depicts wire grid 200A comprising regions enabled by T-gate represented by the connected dots. As depicted in FIG. 6A, less than an entirety of Trojan emission region 202A overlaps with the enabled portions of wire grid 200A, which may result in Vout being lower than if an entirety of the enabled portions covering Trojan emission region 202A. By continuously adjusting the shape or size of the wire grid 200A based on the measured Vout, the exact shape and location of a Trojan emission region may be identified, as depicted in FIG. 6B, where enabled portions of wire grid 200B fully cover Trojan emission region 202B. An accurately outlined Trojan emission region together with an IC's design and layout information may help identify a Trojan and isolate the Trojan from the rest of the IC.

A magnetic antenna array according to various embodiments of the present disclosure may achieve higher resolution and sensitivity in detecting (and defending against) Trojans (or other types of malicious attacks) as compared to conventional magnetic probes. The disclosed magnetic antenna array may also be used to accurately locate a Trojan emission region that conventional magnetic probes cannot. Due to very small distances between layers, sources of magnetic field may be accurately located and induced voltage in an on-chip antenna may be much higher than that in a conventional discrete magnetic probe with a same antenna loop area (based on Equation 1).

As an illustration, in the near magnetic field region, a magnitude of a magnetic field generated from a Trojan may be characterized by Equation 1 where r may represent the distance between the Trojan emission region and a probe. As distance r increases, the magnitude of the magnetic field decreases at a rate of I/r³, where I may represent an electrical current of a Trojan from which the magnetic field is created. According to various embodiments of the present disclosure, a magnetic antenna array may be configured on a metal layer inside an IC chip, and as such, the vertical distance between the magnetic antenna array and a Trojan emission region may be determined by layer thickness. The distance r may be several μm. On the other hand, due to the thickness of the IC packaging, the distance between an external magnetic probe and a Trojan emission region may be, e.g., at least 0.75 mm for Quik-Pak quad flat no-lead (QP-QFN) packaging. As a result, even with a much smaller loop area, the sensitivity of the disclosed magnetic antenna array may be much higher than that of an external magnetic probe.

Based on Equation 1, the much smaller r than conventional magnetic probes may provide the disclosed magnetic antenna array an advantage of using a much smaller loop area on a chip to precisely, closely, or accurately sense magnetic fields with ultra-high resolutions. For example, a distance between two adjacent antenna array wires on a wire grid may be as little as 2 μm, resulting in a resolution as high as 20 μm even if a wire is enabled for every 10 wire distances. On the other hand, a magnetic probe's resolution is limited by diameter. Small diameters have higher resolutions but lower sensitivity because induced voltage of a magnetic probe is proportional to the area A of the probe as given by Equation 2. For example, a Langer EMV LF 1 probe, may provide a resolution of 2 mm, thereby offering a good trade-off between resolution and sensitivity. However, a magnetic antenna array according to various embodiments of the present disclosure may still achieve higher resolution than such conventional magnetic field probes.

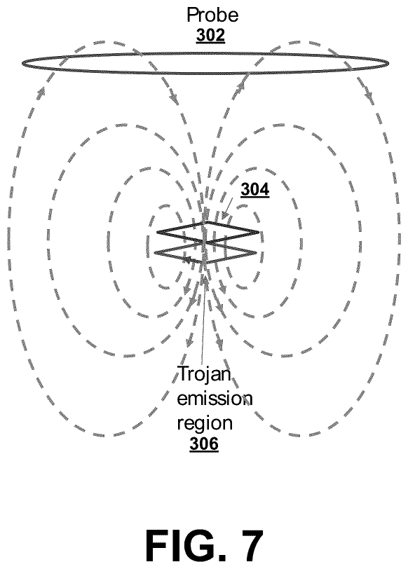

FIG. 7 depicts example measurement capabilities of a conventional magnetic probe. When a conventional magnetic probe 302 is used to measure a magnetic field emitted from a Trojan, Trojan emission region 306, the loop area of the probe 302 can be much larger than the area of Trojan emission region 306, and thus, the magnetic probe 302 may not be able to detect the Trojan. That is, magnetic fluxes flow through loops, which causes cancelation between in and out fluxes associated with the magnetic probe 302, resulting in a very small net magnetic flux linkage in the magnetic probe 302. On the other hand, cancelation may be avoided with a magnetic antenna array according to various embodiments of the present disclosure where flux linkage may only comprise fluxes in one direction. A magnetic antenna array is therefore much superior to a conventional magnetic probe 302 in detecting small Trojans. With very small distance, a magnetic antenna array may be able to accurately sense magnetic fields generated from currents of a small Trojan while a conventional probe may not be able to.

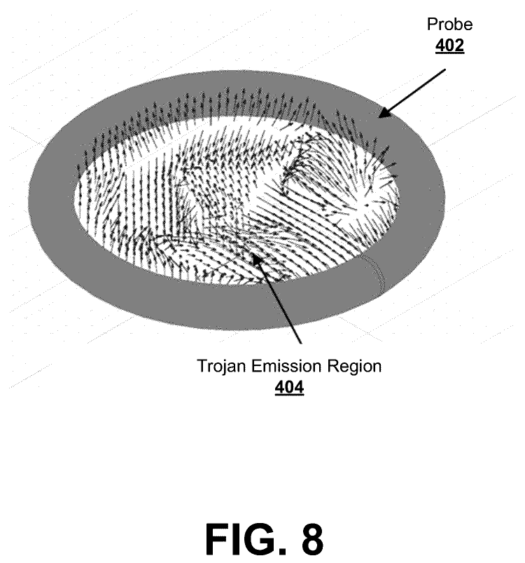

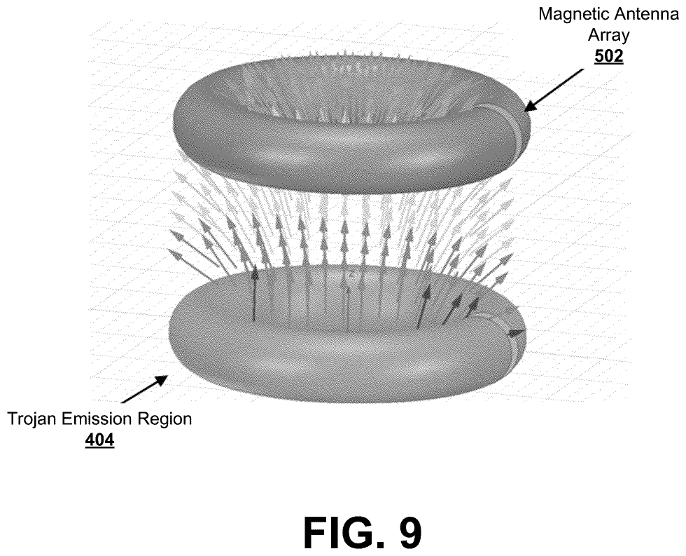

FIG. 8 and FIG. 9 depict full wave three-dimensional simulations of a conventional probe and a magnetic antenna array, respectively. Probe 402 and magnetic antenna array 502 are depicted as circles for the purposes of demonstration and are not limited to any shape or forms.

Probe 402 depicted in FIG. 8 comprises a diameter of 4 mm that is positioned 0.75 mm above an 8 μm Trojan emission region 404 loop carrying a 1 A/50 MHz Trojan current. As depicted in FIG. 8, cancelation of magnetic fluxes exists in the probe 402.

Magnetic antenna array 502 depicted in FIG. 9 comprises an 8 μm diameter that is positioned 6 μm above a same Trojan emission region 404 loop as the conventional probe. The magnetic fluxes in a magnetic antenna array 502 are not canceled, as depicted in FIG. 9, resulting in a higher induced voltage output than that of probe 402.

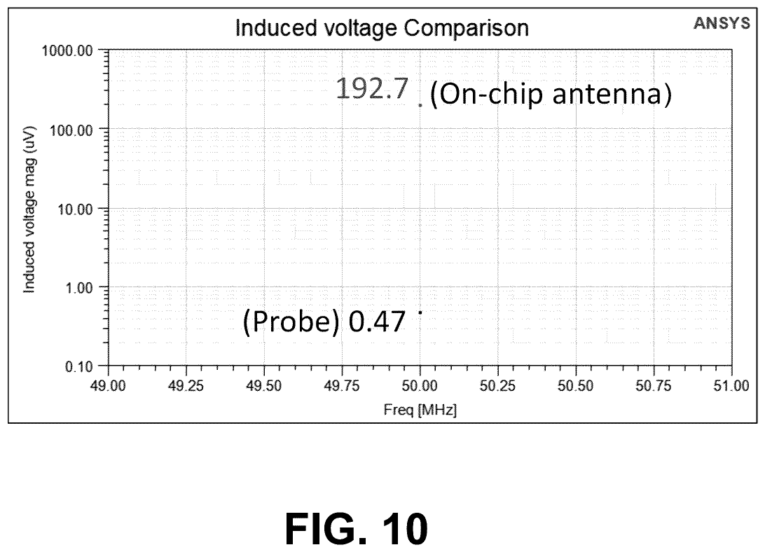

FIG. 10 depicts simulated measurements of induced voltage output of probe 402 and magnetic antenna array 502. As depicted in FIG. 10, the magnetic antenna array 502 can output an induced voltage reading that is approximately 410 times higher than that of probe 402.

### Example Multi-Mode Operation

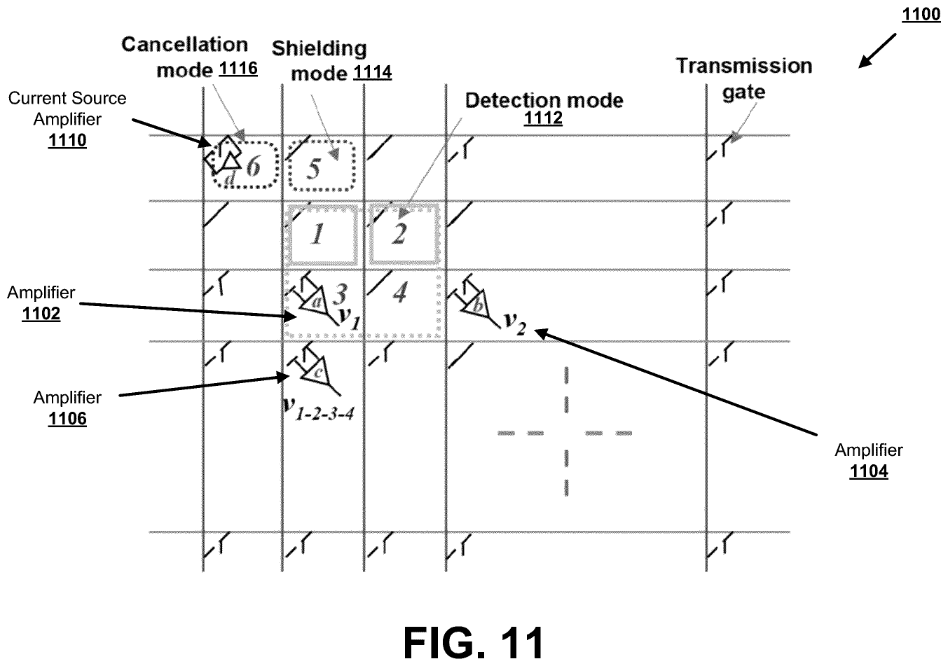

To combat side-channel attacks, fault injections, and HTs in microprocessors/digital ICs, antenna loops generated by a magnetic antenna array according to various embodiments of the present disclosure may be configured in three operation modes: a detection mode, a shielding mode, and a cancelation and interference mode. FIG. 11 depicts an example configuration of a wire grid 1100 (e.g., of a magnetic antenna array) in accordance with some embodiments of the present disclosure. As depicted in FIG. 11, amplifiers may be integrated with the wire grid 1100. A first set of amplifiers, amplifier 1102, amplifier 1104, and amplifier 1106 may amplify induced voltages in antenna loops comprising any of amplifier 1102, amplifier 1104, or amplifier 1106. For example, a magnetic field resulting from one or more of HTs, encryptions, or magnetic field fault injections may induce voltages in antenna loops, and the voltages can be amplified or compensated by the amplifier 1102, amplifier 1104, or amplifier 1106 for post-processing and defense actions. A current source amplifier 1110 may be used to inject a desired current into an antenna loop comprising the current source amplifier 1110 such that the antenna loop may emit a desired magnetic field for defense purposes.

### A. Detection Mode

By configuring the T-gates of the wire grid 1100, it is possible to sense, via a detection mode, a magnetic field (indicative of potential malicious attacks) at any location within an IC embedded with a magnetic antenna array comprising the wire grid 1100 and with any desired shape. Antenna loops formed within the wire grid 1100 may comprise one or more loop units. In some embodiments, the one or more loop units may be configured in a detection mode 1112 by enabling selected ones of T-gates. In the example depicted in FIG. 11, amplifier 1102 and amplifier 1104 can amplify induced voltages from a magnetic field associated with loop units “1” and “2” respectively. On the other hand, the amplifier 1106 can amplify the induced voltages due to the magnetic field coupled to loop unit “1,” loop unit “2,” loop unit “3,” and loop unit “4.” Using a differential amplifier at the outputs of amplifiers 1102, 1004, and 1106, the total voltage induced in loop unit “3” and loop unit “4” can also be derived and amplified. Similarly, the total induced voltage in loop unit “1” and loop unit “2” can also be derived and amplified.

### B. Shielding Mode

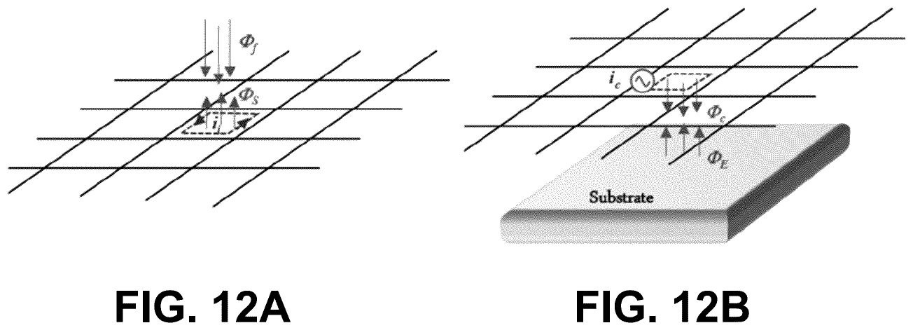

FIG. 11 depicts loop unit “5” configured in a shielding mode 1114, when each of four T-gates on each corner of loop unit “5” are all enabled, thereby creating a short circuit comprising a closed antenna loop. When magnetic field Φ_{f} penetrates loop unit “5,” the induced voltage results in short circuit current ii, which in turn generates an inverse magnetic field Φₛ, as depicted in FIG. 12A, which can partially cancel the original magnetic field Φ_{f}. The same principle can be applied to an antenna loop comprising a plurality of loop units such that the magnetic field of the entire antenna loop can also be partially canceled.

### C. Cancelation and Interference Mode

FIG. 11 depicts loop unit “6” driven by the current source amplifier 1110. The driven currents can generate a desired magnetic field, as depicted in FIG. 12B, for defensive purposes. For example, an inverse magnetic field with a same amplitude as the sensed magnetic field can be generated to cancel an injected magnetic field or side-channel magnetic field leakage from an encryption process of a microprocessors/digital IC. FIG. 11 depicts loop unit “6” configured in a cancelation mode 1116. Loop unit “6” by the current source amplifier 1110 may also be driven to generate a noisy magnetic field with a higher magnitude than the side-channel magnetic field leakage to mask the leakage. This may cause wrong T-scores, making encryption patterns difficult to recognize or totally unrecognizable. The same principle can be applied to an antenna loop comprising a plurality of loop units.

### Example Defense Mechanisms

### A. Defense Against Side-Channel Attacks

As described above, side-channel attacks may be conducted by identifying magnetic field leakage from microprocessors/digital ICs with the help of T-scores and recovering encryption keys by finding correlations between patterns of identified magnetic field leakage traces and patterns of magnetic field leakage traces of known keys with the help of CEMA or AI. Accordingly, embodiments of the present disclosure provide defense against side-channel attacks by preventing identification of magnetic field leakages using T-scores, CEMA, or AI to recover encryption keys.

In some embodiments, magnetic field leakage may be significantly reduced such that T-scores cannot be used to identify the magnetic field leakage. Magnetic field leakage can may be significantly reduced by configuring the disclosed magnetic antenna array to perform active cancelation of the magnetic field leakage (e.g., cancelation via a cancelation and interference mode). In some embodiments, active cancelation is performed by configuring a magnetic antenna array embedded within a target microprocessor/digital IC to (i) operate in a detection mode to detect magnetic field leakage of the target microprocessor/digital IC, (ii) inversely amplify one or more antenna loops of the magnetic antenna array based on detected magnetic field leaks, and (iii) configuring the magnetic antenna array in a cancelation mode to inject electrical currents into the one or more loops to cancel the detected magnetic field leaks.

In some embodiments, magnetic field leakages may be modified such that CEMA and AI cannot be used to recover encryption keys. The magnetic field leakage can be modified by configuring a magnetic antenna array embedded within a target microprocessor/digital IC to operate in an interference mode (of the cancelation and interference mode) to generate a random or encrypted magnetic field interference with comparable magnitude that is coincident with the magnetic field leakage. As such, both CEMA and AI analysis cannot be used to recover encryption keys from magnetic field leakage of a microprocessor/digital IC comprising a magnetic antenna array that is configured accordingly.

In some embodiments, magnetic field leakage may be masked with strong magnetic interference such that T-scores cannot be used to find the magnetic field leakage. Magnetic field leakage can be masked by configuring a magnetic antenna array embedded within a target microprocessor/digital IC to operate in an interference mode to generate a high noisy magnetic field that is coincident with the magnetic field leakage of the target microprocessor/digital IC. By introducing the noisy magnetitic field, T-scores may be distorted with misleading results such that actual magnetic field leakage cannot be identified.

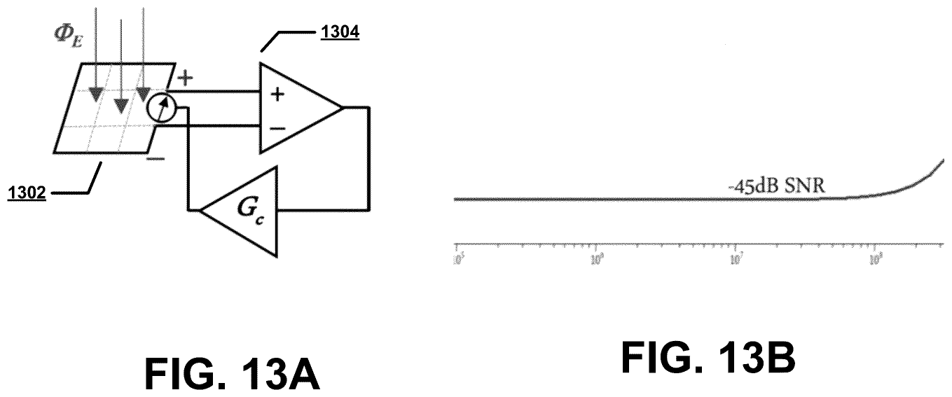

The aforementioned techniques for preventing side-channel attacks may be realized with the disclosed multi-mode configurable on-chip magnetic antenna array, as depicted in FIG. 13A. An antenna loop 1302 of a multi-mode configurable on-chip magnetic antenna array may be driven by a negative feedback-controlled current amplifier 1304 that comprises a wideband loop gain of 40 dB. The antenna loop 1302 may generate a magnetic field that is capable of canceling any side-channel magnetic field leakage from a microprocessor/digital IC by approximately 40 dB (a factor of 100 reduction). As a result, T-scores may be prohibited from identifying magnetic field leakage after cancelation via the antenna loop 1302.

FIG. 13B depicts an example simulated signal to noise ratio (SNR) of the antenna loop 1302 while generating a random noisy magnetic field in accordance with some embodiments of the present disclosure. The depicted example comprises a magnetic field leakage signal that is masked by a random noisy magnetic field generated by a multi-mode configurable on-chip magnetic antenna array with a 45 dB reduction on the SNR, hiding any encryption pattern.

### B. Defense Against Magnetic Field Fault Injections

A magnetic field fault injection may comprise an injection of a high density, high frequency magnetic field into a microprocessor/digital IC. An injected magnetic field can induce high frequency voltages with enough magnitude to falsely trigger gates, resulting in bit flipping and logic errors. To defend against magnetic field fault injections, a defense mechanism is disclosed herewith to significantly weaken an injected magnetic field to prevent faults resulting from magnetic field fault injections.

Defending a target microprocessor/digital IC against magnetic field fault injections may comprise identifying magnetic field fault injection, identifying a location of the magnetic field fault injection, and shielding the magnetic field fault injection.

In some embodiments, identifying a magnetic field fault injection may comprise configuring a magnetic antenna array embedded within a target microprocessor/digital IC to operate in a detection mode to detect an injected magnetic field on the target microprocessor/digital IC. Since the strength of an injected magnetic field would be much stronger than an emitted magnetic field from a microprocessor/digital IC, a magnetic field fault injection can be easily identified based on its magnitude.

In some embodiments, identifying a location of a magnetic field fault injection may comprise configuring a magnetic antenna array embedded within a target microprocessor/digital IC to determine antenna loop units with the highest induced voltages representative of where a magnetic field has been injected.

In some embodiments, shielding an injected magnetic field may comprise configuring a magnetic antenna array embedded within a target microprocessor/digital IC to operate in a shielding mode with T-gates, especially those nearby or adjacent to magnetic field fault injection locations, enabled. Currents induced from injected magnetic fields in closed antenna loop units may be used to generate an inverse magnetic field to cancel the injected magnetic field. As a result, faults may be prevented from occurring.

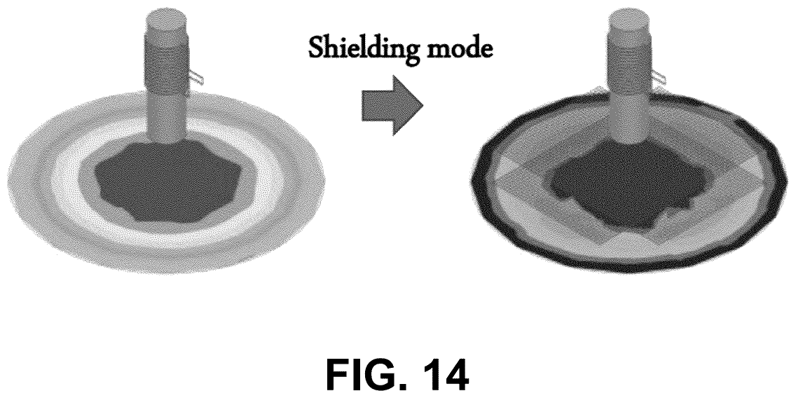

FIG. 14 depicts simulated magnetic field distributions of an injected magnetic field and an application of an induced cancelation magnetic field to the injected magnetic field according to some embodiments of the present disclosure. An injected magnetic field can be used to induce cancelation currents in antenna loops of a magnetic antenna array. For example, the antenna loops may be configured in a shielding mode that induces cancelation currents thereby generating an inverse magnetic field that cancels the injected magnetic field. As depicted in FIG. 14, an injected magnetic field can be reduced by 60%-90% via a cancelation magnetic field. The effectiveness of induced cancelation magnetic fields may be increased by reducing resistance of T-gates and antenna loops.

### C. Defense Against Hardware Trojans

The activities of HTs may generate specific magnetic field patterns. It is therefore possible to detect and identify HTs by their magnetic field leakage. In some embodiments, detecting HTs may comprise measuring magnetic field leakage of a target microprocessor/digital IC by configuring a magnetic antenna array embedded within the target microprocessor/digital IC to operate in a detection mode. Magnetic field leakage traces may be generated based on measurements taken of a microprocessor/digital IC by a magnetic antenna array embedded therewith. T-scores may be calculated for measured magnetic field leakage traces and compared with T-scores of reference magnetic field leakage traces without Trojans and/or with inactive Trojans (e.g., from a HT database). If the difference between the compared T-scores is greater than a threshold, one or more Trojans may be present and detected as such. A T-score heatmap may be generated using the calculated T-scores. The Trojan's leakage location may be determined based on the T-score heatmap.

In some embodiments, a type of Trojan or properties of a Trojan may be identified by applying CEMA or AI between measured magnetic field leakage traces and magnetic field leakage traces from an existing known HT database. Upon HT detection and identification, a microprocessor/digital IC may be alerted for further actions.

### Example Amplifier Design and Cross-Domain Analysis

### A. Magnetic Antenna Array Impedance and Amplifier Design

T-gates and wires of the disclosed magnetic antenna array may have significant resistance due to both having small cross-sectional areas on a microprocessor/digital IC chip. Furthermore, output impedance of a magnetic antenna array is inductive due to the magnetic antenna array having inductance. The magnetic antenna array may therefore have a high output impedance. The high output impedance can distort and reduce output voltage of the magnetic antenna array due to a voltage drop and phase shift on the output impedance. This may lead to incorrect information for Trojan detection or identification. To accurately sense a magnetic field of a microprocessor/digital IC embedded with a magnetic antenna array, amplifiers may be designed to increase the input impedance of the magnetic antenna array or to compensate for distortions such that fidelity of a sensed magnetic field can be preserved.

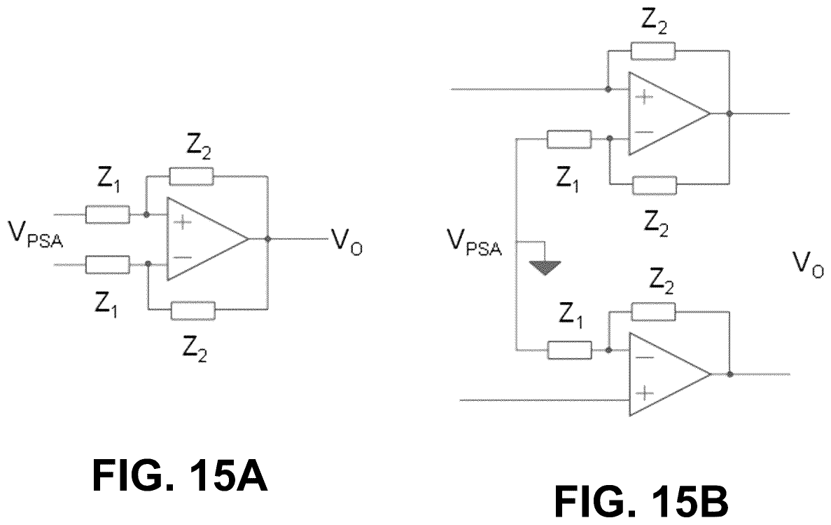

FIG. 15A and FIG. 15B present example differential amplifiers for increasing input impedance of magnetic antenna arrays according to some embodiments of the present disclosure. Differential amplifiers may be preferred because magnetic antenna arrays comprise balanced outputs. FIG. 15A depicts a single operational amplifier (op amp) configuration and FIG. 15B depicts a two op amp configuration with high input impedance. The input impedance of the op amp in FIG. 15A is 2Z1 and the input impedance of the op amp in FIG. 15B is very high because the input impedances of the two op amps are in the input loop.

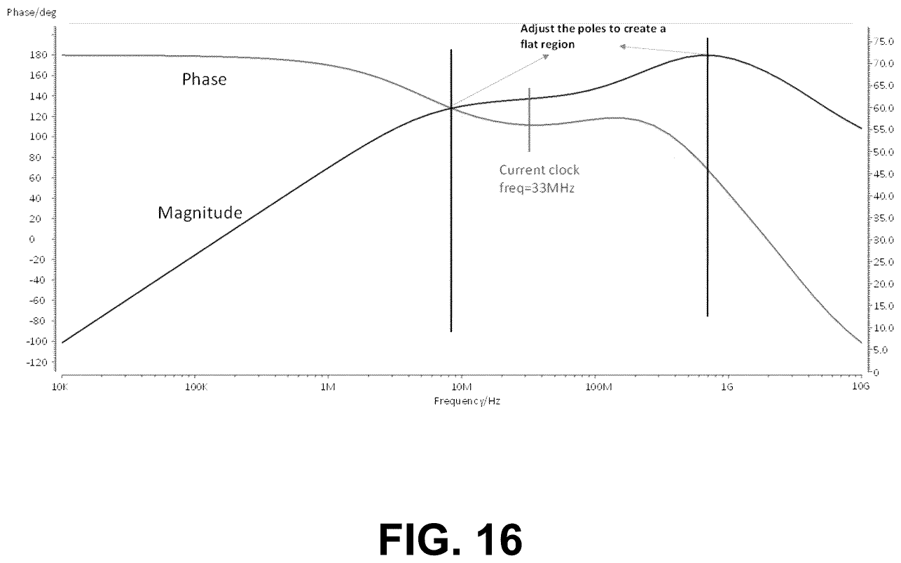

Output impedance of a magnetic antenna array may be utilized as Z1 for the op amp in FIG. 15A, and the feedback impedance Z2 is designed to compensate for any significant distortion introduced as depicted in FIG. 16, such that the magnetic antenna array's high inductive output impedance issue may be solved. In FIG. 16, a frequency response in the desired frequency range is from one-tenth of the central clock frequency to 10 times the clock frequency, covering most toggling behaviors in an IC chip. The poles of the op amps may be adjusted to compensate for the magnetic antenna array output impedance and op amp's gain characteristics such that a flat gain is approximately achieved from 60-70 dB.

### B. Cross-Domain Trojan Identification Technique

A cross-domain technique performed by one or more processors is disclosed herewith to detect and identify Trojans using the disclosed magnetic antenna array. A Trojan may be detected with information in the frequency spectrum of measured leakage magnetic field. In particular, active Trojans may be identified based on frequency spectrum signatures found in induced voltage measured via a magnetic antenna array in the frequency domain by comparing the frequency spectrum with one or more frequency spectrums without active Trojans.

Specific types of Trojans may be identified by examining frequency components within a Trojan frequency spectrum signature, such as frequency components in a signature carrier frequency's sideband that may be explored in the time domain using a zero-span mode of a spectrum analyzer. The zero-span mode may show a magnitude change as a function of time for a single frequency signal, therefore, full time-domain information of Trojan-signature frequency components may be fully examined. In zero-span mode, by comparing the time domain waveform of a single signatured-frequency component with frequency components of one or more known HTs, a specific HT may be identified.

Compared with conventional time domain or frequency domain Trojan detection techniques, the disclosed cross-domain technique has an advantage of fully examining time domain information of each Trojan-signatured frequency component. Conventional time domain techniques may only examine a time domain waveform with a plurality of frequency components superposed where unimportant frequency components with big amplitudes can mask signatured-frequency components with small magnitudes. This makes conventional time domain techniques non-ideal for detecting and identifying Trojans with small magnetic field leakage. Conventional frequency domain techniques are limited to comparing spectrum with and without active Trojans to detect a Trojan and fails to examine time domain information of individual signatured-frequency components, and thus cannot be used to identify specific HTs.

### Exemplary System Operations

Various embodiments of the present disclosure describe steps, operations, processes, methods, functions, and/or the like for preventing malicious attacks on an IC.

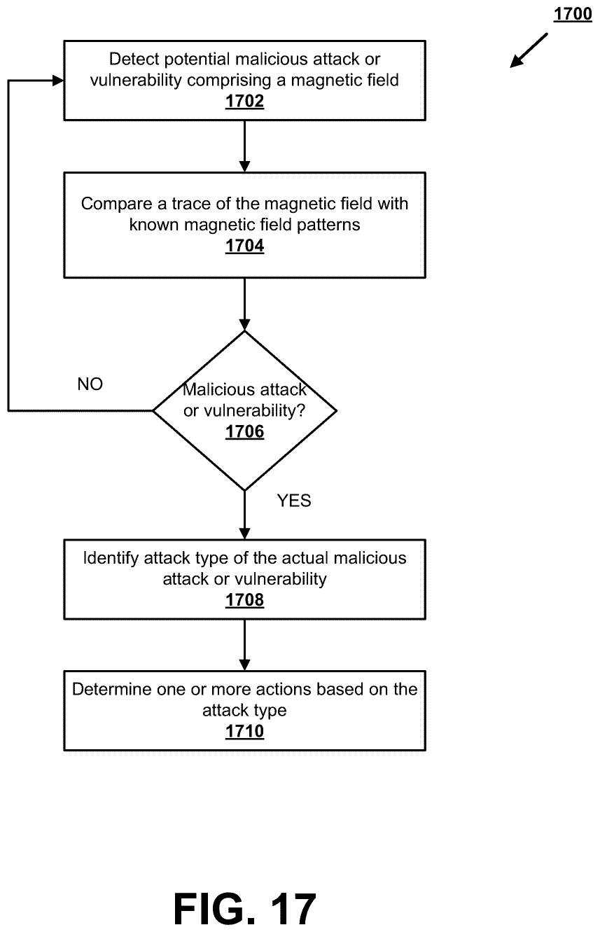

FIG. 17 presents a flowchart of a method for preventing malicious attacks on an IC in accordance with some embodiments discussed herein. The process 1700 includes example operations that may be performed by a microprocessor or digital IC embedded with a magnetic antenna array, as disclosed herewith. In some embodiments, the process 1700 may be performed by a computing apparatus coupled to the microprocessor or digital IC, and the computing apparatus may comprise one or more of processing elements (also referred to as processors, processing circuitry, and/or similar terms used herein interchangeably), non-volatile memory, volatile memory, a network interface, and/or the like, for performing the example operations.

At step 1702, a potential malicious attack or vulnerability comprising a magnetic field located within the microprocessor or digital IC embedded with the magnetic antenna array is detected. The potential malicious attack or vulnerability may be detected by configuring one or more T-gates of the magnetic antenna array in a detection mode to sense for magnetic fields at locations within the microprocessor or digital IC embedded with the magnetic antenna array. In some embodiments, the one or more T-gates may be programmed to control the connectivity of one or more intersections horizontal and vertical wires of a wire grid to configure shape, location, or size of antenna loops that may be generated by the magnetic antenna array for fine-tune sensing and location of magnetic fields associated with potential malicious attacks. For example, magnetic fields detected within a microprocessor or digital IC may comprise malicious attack activities exhibited by magnetic field leakage. In some embodiments, detecting the potential malicious attack or vulnerability may further comprise detecting a location of the magnetic field, which in some embodiments, may be representative of a location of a HT or circuitry comprising malicious hardware.

At step 1704, a trace of the magnetic field is compared with known magnetic field patterns. In some embodiments, a trace of the magnetic field may be generated and compared with normal magnetic field characteristics of the microprocessor or digital IC without malicious attack activity (e.g., using a cross-domain technique). In some embodiments, the trace of the magnetic field may be compared with magnetic field characteristics of known malicious attacks, such as magnetic field fault injection and hardware/software anomalies. In some embodiments, T-scores may be calculated for the magnetic field trace and compared with T-scores of reference magnetic field traces without hardware/software anomalies and/or with inactive hardware/software anomalies (e.g., from a hardware/software anomaly database). For example, magnetic field traces at various locations above the microprocessor or digital IC can be compared using T-scores with the ones without the hardware/software anomalies or the ones when inactive hardware/software anomalies to determine the presence of hardware/software anomalies.

At step 1706, a determination is made whether the potential malicious attack or vulnerability is an actual malicious attack or vulnerability based on the comparison of the magnetic field trace with the known magnetic field patterns. The comparison may comprise determining similarity and/or dissimilarity between the magnetic field trace and the known magnetic field patterns that exceed a predetermined similarity/dissimilarity threshold. If the comparison comprises the magnetic field trace matching normal magnetic field patterns or not matching magnetic field characteristics of known malicious attacks or vulnerabilities, the potential malicious attack or vulnerability is determined as not a malicious attack or vulnerability, and the process may return to step 1702 to detect another potential malicious attack or vulnerability. However, if the comparison comprises the magnetic field trace not matching normal magnetic field patterns or matching magnetic field characteristics of known malicious attacks or vulnerabilities, the potential malicious attack or vulnerability is determined as an actual malicious attack or vulnerability.

At step 1708, an attack type of the actual malicious attack or vulnerability determined by step 1706 is identified. Example types of malicious attacks or vulnerabilities that may be identified include side-channel attacks, magnetic field fault injection, and HTs. Side-channel attacks may be associated with a vulnerability associated with identifying and probing magnetic field leakage from a microprocessor/digital IC. In some embodiments, a magnetic field fault injection attack may comprise injecting a magnetic field that is much stronger than an emitted magnetic field from the microprocessor or digital IC and thus can be identified based on magnitude. According to another embodiment, a type of Trojan or properties of Trojans may be identified based on magnetic field leakage traces from an existing known HT database. For example, a Trojan and type of Trojan may be detected by comparing information in the frequency spectrum signature of the magnetic field and examining frequency components of the magnetic field with reference to frequency spectrum signatures of specific types of Trojans.

At step 1710, one or more actions are determined based on the attack type. The one or more actions may comprise configuring one or more T-gates of the magnetic antenna array to create antenna loops operating in at least one of shield, or cancelation and interference modes. For example, antenna loops may be configured in a shielding mode to reduce magnetic field leakage to remedy side-channel attack vulnerability. According to other examples, side-channel attack vulnerability may also be remedied by configuring antenna loops in a cancelation and interference mode to (i) render magnetic field leakage unusable to recover keys from magnetic field leakage, via modification or encryption, or (ii) mask the magnetic field leakage with strong magnetic interference such as a high noise magnetic field. In some embodiments, antenna loops of a magnetic antenna array may be configured to operate in a shielding mode to remedy a magnetic field fault injection attack. For example, currents induced from an injected magnetic field in a closed antenna loop can be used to generate an inverse magnetic field to cancel the injected magnetic field to prevent faults from occurring.

### Theory of Experimental Implementation of Various Embodiments

Taping out a chip with a Programmable Sensor Array (PSA) may begin with a detailed design phase. Conceptualizing a purpose of the PSA in the chip may be essential to focus on its intended functionalities and integration with other systems. A schematic may be generated using electronic design automation (EDA) tools, where the electrical characteristics and interconnections of the PSA and other components may be defined. The PSA itself may be configured according to specific requirements, including sensor count, layout, and programmability. Simulation tools, such as Cadence or Synopsys may be employed to test the chip's functionality and performance, ensuring alignment with desired specifications. The design may then be translated into a physical layout, marking the precise placement and routing of the PSA and all other chip elements. This layout phase may be critical as it directly impacts the manufacturability and performance of the final chip.

Once design and layout of the chip are complete, the chip may undergo rigorous verification and testing, such as a design rule check (DRC) to ensure compliance with fabrication standards and a layout versus schematic (LVS) check to confirm that the layout accurately reflects the schematic design. Parasitic elements may be extracted from the layout to assess their impact on chip performance. Post-layout simulation including parasitic effects from the parasitic element may be crucial to validate a final design of the chip. The tape-out process may then commence with a final review followed by a generation of fabrication files, for example, in graphic design system (GDSII) format. The fabrication files may be sent to a semiconductor foundry where chip fabrication takes place, which may involve a series of complex processes such as photolithography, etching, and doping. Upon fabrication, the foundry may conduct tests to ensure quality standards are met. A final fabrication stage may comprise inspecting the received chips, conducting comprehensive testing to validate the PSA's functionality, and integrating the chip into its target application for further development and system-level testing.

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. An integrated circuit comprising:
a magnetic antenna array comprising:
a wire grid spanning two metal layers comprising horizontal wires and vertical wires;
a switch at each intersection of the horizontal wires and the vertical wires, wherein each switch comprises a transmission gate; and
one or more antenna loops, wherein for each intersection, the transmission gate is programmable to control connectivity at the intersection forming the one or more antenna loops.

2. The integrated circuit of claim of 1, wherein at least one of shape, location, or size of the wire grid are configurable by enabling selected ones of switches associated with one or more intersections of the horizontal wires and the vertical wires.

3. The integrated circuit of claim of 1, wherein the magnetic antenna array is configured to locate magnetic field leakage of hardware Trojans.

4. The integrated circuit of claim 1, wherein an induced voltage output is generated by the magnetic antenna array based on a capture of electromagnetic emissions from hardware Trojans by the wire grid.

5. The integrated circuit of claim 4 further comprising an operational amplifier configured to amplify the induced voltage output.

6. The integrated circuit of claim 1, wherein the one or more antenna loops comprise one or more loop units.

7. The integrated circuit of claim 1, wherein the one or more antenna loops are configurable in at least one of a detection mode, a shielding mode, or a cancelation and interference mode.

8. The integrated circuit of claim 7, wherein the shielding mode comprises activation of T-gates on each corner of a selected loop unit to create a short circuit.

9. The integrated circuit of claim 8, wherein the selected loop unit generates an inverse magnetic field based on a short circuit current associated with voltage induced by a magnetic field penetrating the selected loop unit.

10. The integrated circuit of claim 7, wherein the cancelation and interference mode comprises generating a noisy magnetic field.

11. A computer-implemented method comprising:
receiving, by one or more processors, frequency spectrum data based on induced voltage measured of an integrated circuit, the spectrum data received from a magnetic antenna array embedded within the integrated circuit, the magnetic antenna array comprising a wire grid, wherein the wire grid comprises (i) a wire grid spanning two metal layers comprising horizontal wires and vertical wires, (ii) a switch at each intersection of the horizontal wires and the vertical wires, wherein each switch comprises a transmission gate, and (iii) one or more sensing areas;
determining, by the one or more processors, one or more spectrum signatures in the spectrum data by comparing the spectrum data with spectrum data without active hardware Trojans;
for each of the spectrum signatures, analyzing, by the one or more processors, one or more frequency components of a spectrum signature in a time domain based on a magnitude change as a function of time; and
determining, by the one or more processors, an identification of one or more hardware Trojans by comparing the one or more frequency components of the spectrum signature with frequency components of one or more known hardware Trojans.

12. The method of claim 11 further comprising:
measuring magnetic field leakage of the integrated circuit based on a configuration of the magnetic antenna array in a detection mode;
generating magnetic field leakage traces based on the measured magnetic field leakage;
calculating T-scores for the magnetic field leakage traces;
comparing the T-scores with reference T-scores associated with magnetic field leakage traces not associated with the one or more known hardware Trojans; and
determining a presence of the one or more hardware Trojans based on the comparison.

13. The method of claim 12 further comprising:
generating a T-score heatmap based on the calculated T-scores; and
determining one or more leakage locations associated with the one or more hardware Trojans based on the T-score heatmap.

14. The method of claim 11 further comprising:
detecting a potential malicious attack or vulnerability comprising a magnetic field located within the integrated circuit;
comparing a trace of the magnetic field with known magnetic field patterns;
determining the potential malicious attack or vulnerability is an actual malicious attack or vulnerability based on the comparison;
determining an attack type of the actual malicious attack or vulnerability; and
determining one or more actions based on the attack type.

15. An integrated circuit comprising:
a target circuit; and
a magnetic antenna array embedded within the target circuit, the magnetic antenna array comprising one or more antenna loops formed by a plurality of connections between a plurality of intersecting horizontal and vertical wires, the magnetic antenna array configured to reduce magnetic field leakage by:
detecting a magnetic field leakage of a target circuit by configuring the magnetic antenna array to operate in a detection mode;
inversely amplifying the one or more antenna loops based on the magnetic field leakage; and
canceling the magnetic field leakage by configuring the magnetic antenna array in a cancelation mode that injects electrical currents into the one or more antenna loops of the magnetic antenna array.

16. The integrated circuit of claim 15, wherein the magnetic antenna array is configured to modify the magnetic field leakage by operating in an interference mode that causes the magnetic antenna array to generate a magnetic field interference that is coincident with the magnetic field leakage.

17. The integrated circuit of claim 15, wherein the magnetic antenna array is configured to mask the magnetic field leakage by operating in an interference mode that causes the magnetic antenna array to generate a noisy magnetic field interference that is coincident with the magnetic field leakage.

18. The integrated circuit of claim 15, wherein the magnetic antenna array is configured to defend the target circuit against one or more magnetic field fault injections by:
operating in a detection mode that causes the magnetic antenna array to detect a magnetic field fault injection on the target circuit; and
operating in a shielding mode that causes the magnetic antenna array to enable one or more transmission gates that are adjacent to a location of the magnetic field fault injection to shield the magnetic field fault injection.

19. The integrated circuit of claim 18, wherein the location of the magnetic field fault injection is associated with one or more antenna loop units comprising highest induced voltages.
